(19) United States
(12) Patent Application Publication
(10) Pub. No.: US 2009/0063304 A1
(43) Pub. Date: Mar. 5, 2009

(54) System and method for searching, identifying, and ranking merchants based upon preselected criteria such as social values

(76) Inventor: Anthony Meggs, Rockledge, FL (US)

Correspondence Address: HAYWORTH, CHANEY & THOMAS, P.A., 202 N. HARBOR CITY BLVD., SUITE 300, MELBOURNE, FL, 32935, US

(21) Appl. No.: 12/231,269

(22) Filed: Aug. 29, 2008

Related U.S. Application Data
(60) Provisional application No. 60/966,571, filed on Aug. 29, 2007.
(60) Provisional application No. 60/966,755, filed on Aug. 29, 2007.

(51) Int. Cl. G06Q 30/00

(52) U.S. Cl. 705/27

(57) ABSTRACT

A social purchasing, networking, and ranking method and system for linking consumers and merchants who share similar social values, personal values, and personal contacts or referrals. The present invention may allow both a consumer and merchant to associate specific criteria such as personal values, religious faith, hobbies, interests, affiliations, political party, favorite charitable organization, social responsibility value, and the like with their respective profiles. A conventional electronic network, or web, search by the consumer launches a first graphical user interface module wherein a list of participating merchants is searched for keyword matches, and then ranked according to the preselected criteria such as the social values, personal referrals, and geographic location of the participating merchant. The present invention allows a user (consumer) to guide their transactions and interactions toward merchants sharing similar values, interest, affiliations, and the like, to further rank merchants by personal referral and geographic proximity to the user. Additionally, the specific type and number of shared criteria may be graphically depicted to the consumer via at least one icon displayed in conjunction with the advertisements or other information displayed by each of the respective participating merchants.

### CROSS REFERENCE TO RELATED APPLICATIONS

This application claims the benefit of provisional patent application Ser. No. 60/966,571, filed with the USPTO on Aug. 29, 2007, provisional patent application Ser. No. 60/966,755, filed with the USPTO on Aug. 29, 2007, utility patent application Ser. No. 11/267,210 filed with the USPTO Nov. 7, 2005, and utility application Ser. No. 11/708,587 filed with the USPTO Feb. 21, 2007 which are all herein incorporated by reference in their entirety.

### STATEMENT REGARDING FEDERALLY SPONSORED RESEARCH OR DEVELOPMENT

Not applicable.

### INCORPORATION-BY-REFERENCE OF MATERIAL SUBMITTED ON A COMPACT DISK

Not applicable.

### BACKGROUND OF THE INVENTION

1. Field of the Invention

The present invention generally relates to data processing. More particularly, the present invention relates to a method and system for generating, ranking, and presenting merchant search results that are presented to a user in the form of a ranked list wherein ranking is based upon the ranking of search results by one matching at least one, but preferably more than one, criteria such as shared social values, favorite charitable organization, favorite non-profit organization, religious faith, political party affiliation, geographic location, referrals, or other preselected criteria.

2. Background Art

The World Wide Web is often utilized by users (e.g. consumers) to identify merchants who offer products or services filling a need or desire of the user. These merchants utilize the World Wide Web to present their products or services to the user by describing their products or services in a web site which is cataloged or indexed by a web crawler, and which index is then searched when a user inputs a keyword or key phrase into a web browser software program. The web browser software program then searches the catalog or index of web sites for web sites containing product or service descriptions that contain words or phrases matching the keyword or key phrase input by the user, and a resulting list of “hits”, i.e. a list of web sites that match the key word or key phrase input by the user, is generated and presented to the user by the web browser software program. Such a list of hits may contain not only web sites of merchants who offer goods and services matching the key word or key phrase input by the user, but may also contain the web sites of non-merchants. Thus the user may have to review numerous web sites, including web sites of non-merchants, to try to find a merchant who offers the particular product or service they are seeking.

A social network site is an on-line (i.e., Web, Internet, etc.) site that provides a virtual community for on-line users (i.e., user members) who may have related or similar interests. Social network site users may interact and communicate with one another via blogging, instant messaging, posting messages, e-mailing, etc., about shared interests and points of discussion. Social network site concepts and features are described in U.S. Patent Application Publication No. 2005/0177385 (entitled “Method and System for Customizing Views of Information Associated with a Social Network User”) which is hereby incorporated by reference in its entirety.

Each user of a social network site generally presents a user profile to the social network site. A user may populate his/her user profile with general and personal information about the user. For example, a user profile of a user may include: alternate names or aliases; personal contact information (e-mail address, etc.); contact information of friends or relatives; residence; age; interests (sports, religion, hobbies, etc.); occupation; gender; marital status; list of other users of the social network site who are friends, family, co-workers, colleagues, etc.; on-line and off-line group memberships or affiliations; strength of relationships with other users of the social network site; etc.

As such, some users of social network sites have similar profiles in that, for example, they share the same occupation, have the same interests, belong to the same group, etc. Accordingly, these users have trusted relationships with one another in that they have something in common. These trusted relationships can strengthen as these users communicate with one another online and/or offline. Likewise, users who have similar profiles in that they are friends, family, co-workers, colleagues, etc., of one another have trusted relationships as they are likely to be familiar with one another. Even if such users are strangers these users still have trusted relationships as they belong to the same group and are likely to know other users in the group who know the users that are strangers. Again, these trusted relationships can strengthen as these users communicate with one another. Generally, people such as users of social network sites value the opinions of other people they trust and who have similar social values, political party affiliates, shared religious faith, or shared interests or tastes as themselves (i.e., those people with which they have trusted relationships).

In addition to enabling a user's ability to search the World Wide Web for the web sites of merchants offering products and services and enabling social network sites, Internet providers enable users to perform on-line searches to locate desired information. In operation, an on-line search provider usually presents the search results to the user in a listing. If there are a relatively large number of search results, the provider organizes the search results into groups in which a first group is presented to the user, then a second group, and so on. The provider may organize the search results into numerical order and groups based on factors which are not necessarily in the interest of the user. For example, the provider may place search results associated with a customer of the provider higher than other search results even though the other search results appear to contain the desired information, whereas the search results associated with the customer do not. Furthermore, some of the search results may appear to contain the desired information even though they do not.

As such, the desired information may be included in the search results but the user does may actually obtain the desired information because the desired information may be presented in a later group and the user gives up reviewing the search results before reaching this group; the user confuses information in the search results as being the desired information when in reality it is not the desired information; other information in the search results fraudulently or inadvertently appears to be the desired information; or other reasons based upon the operation of traditional search engines. Additionally, the user may not want to rely upon the results obtained as they may not be familiar with the source or they may believe that the source may be biased, as, for example, the situation in which a company is promoting its own products over the products of competitors.

As an example of on-line searching for ‘trusted’ product, service, or web site information in its current form, an on-line user investigates a product of interest to the user in accordance with the following paradigm. First, the user conducts a search of on-line content containing or related to a ‘keyword(s)’ identifying the product of interest. A keyword may be comprised of a single word or multiple words forming a phrase of words. For example, if a user is interested in purchasing a digital camera and is attempting to locate merchants who offer digital cameras, the user may input the keyword ‘digital camera’ into a web search engine through a web browser interface. In response, the web search engine searches for web sites whose content is related to digital cameras. The algorithms for performing such searches and presenting the search results to a user are generally sophisticated software programs that are well known in the art. Continuing with the example of the digital camera, it can be expected that there are many web sites containing information regarding digital cameras, and the web search engine will generate a list of hits to present to the user whic contains an enormous number of web sites matching the user inputted key phrase ‘digital camera’. As such, the web search engine or web browser organizes the located content (i.e., the search results or “hits”) into numerical orders and groupings and then presents same to the user. Typically, entries of titles and short descriptions of the presented content (i.e. the web sites of the resulting list of hits) are initially presented to the user who, in turn, may ‘click’ on an entry to obtain the full document, web site, etc., associated therewith. For example, the clicked content may contain reviews submitted by other people regarding certain types of digital cameras, descriptions of digital cameras offered for sale by a merchant, general information regarding the technology enabling digital cameras, information about the manufacturers of digital cameras, ‘how-to’ information regarding the use of digital cameras, and the like. The user may then read or access the clicked content to read the information provided on the web sites of the list of hits regarding digital cameras.

One problem with this scenario of on-line searching in its current form is that the user has no way of knowing whether the web sites presented in the list of hits are actually the web site of a merchant who is offering the desired product or is simply an informational web site, whether the information provided on the web sites presented in the hit list is truthful or reliable, whether the owner of the web sites presented in the hit list share the same social values, affiliations, contacts, and the like of the user, and so forth. In other words, the user has no idea whether the merchants presented in the list of hits have any shared interest with the user; thus the user is uncertain whether it is desirable to do business with the a particular merchant. It is desirable that the user gain some understanding of whether there is a shared interest between the user and any particular merchant so that the user can gain some confidence that they indeed wish to conduct business with a particular merchant, and to efficiently sort the resulting list of hits to present those web sites of merchants who have a shared interest with the user in some sort of prioritized fashion. More particularly, it is desirable that the entries of the list of hits be presented to the user in a prioritized fashion based upon criteria the user has preselected to be of importance to them. It is understood that different users will place different values on various criteria, and thus it is desirable that the web browser software program of the digital camera example understand which criteria are most important to the user such that the presentation of the list of hits to the user is made in a prioritized fashion based upon the specific predetermined desires of the user. Thus, it would be desirable if the entries of the search result which are related to a profile of the user were presented (i.e., ranked) at the top of the search result listing for the user. Likewise, it would be desirable if the entries of the search result which are related to preferences of a group to which the user belongs were presented (i.e., ranked) at the top of the search result listing for the user. The present invention enables such desirable features and is a significant improvement over the current state of the art.

As another example of the problem associated with on-line searching in its current form, consider a web site directed to hotels. Such a web site includes reviews of hotels. A problem for the user when reading the reviews is that the user has no idea whether the reviews are truthfully written. For instance, a hotel may encourage a person with an incentive to write a flattering review of the hotel. Likewise, the user reading a review of a hotel has no idea as to whether the person writing the review has the same likes, dislikes, values, or preferences as the user. That is, the user does not know how much the user has in common with the person writing the review. It it thus desirable that the reviews be written by people having something in common, or some shared value or set of shared values, with the user and it is also desirable that the user be able to gain some understanding as to whether a review has been written by an author the user trusts because of a personal connection such as friendship, family, business affiliation, social affiliation or the like between the user and the review writer. Again, the present invention enables such desirable features and is a significant improvement over the state of the art.

In sum, the current paradigm for a user to learn about a product of interest to the user is the user (a) conducting a search to locate information regarding the product; (b) finding websites containing information about the product in the located information; and (c) reading the information contain on such web sites. The current paradigm can be termed as a “search” and, as indicated above, generally suffers from the problem of being carried out without regard to whether the search results match the perspectives, preferences, social values, social connections and the like of the user.

Despite reaching good ranking results, search engines limited to traditional rankings do not include user profiles, values, interests, personal contacts, affiliations, connections to charitable organizations and the like in determining the relevancy of results and in presenting those results to the user. In fact, the search engines of the prior art do not have the capability to obtain such information from the user or from the merchant. Most traditional search engines cannot consider such value ranking because they do not have the ability to query the user or merchant for entry of such information; thus they are not enabled to present a list of hits, or search results, to the user presented in priority of preselected criteria. Traditional results rankings are simply based upon a theory that, for a given query and a given set of documents, the resulting hits are all equally relevant to all users irrespective of the social values, affiliations, personal contacts, and the like of the user. Thus, under the legacy art, even if the user desires to interact with merchants who share their personal values and network, they are unable to effectively do so because they are left to themselves to contact or otherwise research the results (the merchants whose links are displayed in the results) in order to gain an understanding as to whether the results match the personal values, affiliations, personal network, connection to charitable organizations, and the like of the user. Such research is time consuming and is therefore generally not performed by the user. It is therefore desirable, for example when a user is attempting to search the world wide web for merchants who are offering a particular product or service intended to be purchased by the user with the goal of locating a merchant who shares the same social values, personal contacts, etc. as the user, that a method and system be provided in which the user's personal criteria for merchant selection are first obtained by the method and system, compared to the values, network, charitable organizations, affiliations, and the like of the merchants of the results, and that a ranking of results presented to the user in order of a priority of criteria selectable by the user in an easily understandable graphical interface.

The method and system of the present invention overcomes the obstacles of the current art by enabling users to enter preselected criteria into the method and system of the invention, and by allowing merchants to enter preselected criteria into the method system of the invention, which in turn enables the method and system of the invention to rank results by similarity between the preselected criteria of the user and the preselected criteria of the merchant, resulting in a ranked list, so that the ranked list can be presented to the user by displaying in a graphical user interface. In addition, the present invention enables the user to choose which criteria are to be used for ranking. Thus, in use, the user can feel confident and purchase products and services from individuals or companies closely matching the user's inputted preselected criteria in regards to personal values, interests, affiliations, social responsibility issues, and the like.

### BRIEF SUMMARY OF THE INVENTION

In accordance with one embodiment of the present invention, a method of linking at least one user with at least one participating merchant sharing at least one preselected criteria, via an electronic network, is disclosed, said method comprising the steps of: obtaining at least one user preselected criteria; storing said user preselected criteria; obtaining at least one participating merchant preselected criteria; storing said at least one participating merchant preselected criteria; obtaining at least one product or service description from said at least one participating merchant; obtaining an electronic network search keyword from said at least one user; producing a list of results comprising at least one participating merchant by matching said electronic network search keyword to said at least one product or service description; producing a ranked list of results by ranking said list of results by matching said at least one user preselected criteria to said at least one merchant preselected criteria, and applying an importance rating predetermined by at least said one user; and displaying said ranked list of results within a first graphical user interface module.

In accordance with an additional embodiment of the present invention, a method of linking at least one user with at least one participating merchant sharing at least one preselected criteria via an electronic network is disclosed, said method comprising the steps of obtaining an electronic network search, wherein the electronic network search comprises at least one keyword, comparing the at least one keyword of said electronic network search to descriptions of products or services available from the at least one participating merchant, ranking the at least one participating merchant having the goods or services available based on the level of similarity of the at least one preselected criteria of the at least one user and the at least one preselected criteria of the at least one participating merchant, and displaying a ranked list of results of the at least one participating merchant to the at least one user, wherein the ranked list of results is displayed within a first graphical user interface module.

The present invention further comprises an apparatus linking at least one user with at least one participating merchant sharing at least one preselected criteria via an electronic network, said apparatus comprising a memory that stores executable instructions for ranking the at least one participating merchant having products or services available based on the at least one preselected criteria and a processor that executes the instructions to: obtain an electronic network search from the at least one user, wherein the electronic network search comprises at least one keyword, compare the at least one keyword of the electronic network search to descriptions of the products or services available from the at least one participating merchant, rank the at least one participating merchant having the goods or services available based on the level of similarity of the at least one preselected criteria of the at least one user and the at least one preselected criteria of the at least one participating merchant, and display a ranked list of results of the at least one participating merchant to the at least one user, wherein the ranked list of results is displayed within a first graphical user interface module.

Such aspects may allow for a user to find and select a merchant from which the user will purchase products or service wherein the merchant shares one or more common traits such as personal values, social values, interests, affiliations, and the like that are important to the user. The present invention may further include displaying at least one icon with each search result to depict the type and/or number of shared traits between the user and the listed merchant. Such designated common traits may be independently selected by the user and the search results may be weighted by the number and/or type of common traits found. In this manner, displaying a search result includes displaying the search result based on the factors chosen by the user.

The present invention is described in detail below with reference to the accompanying drawings

### BRIEF DESCRIPTION OF THE DRAWINGS

FIG. 1 depicts a schematic diagram typical search engine technologies in accordance with the prior art.

FIG. 2 depicts a typical search result in accordance with the prior art.

FIG. 3 depicts a flow chart diagram of a typical search performed by a typical search engine in accordance with the prior art

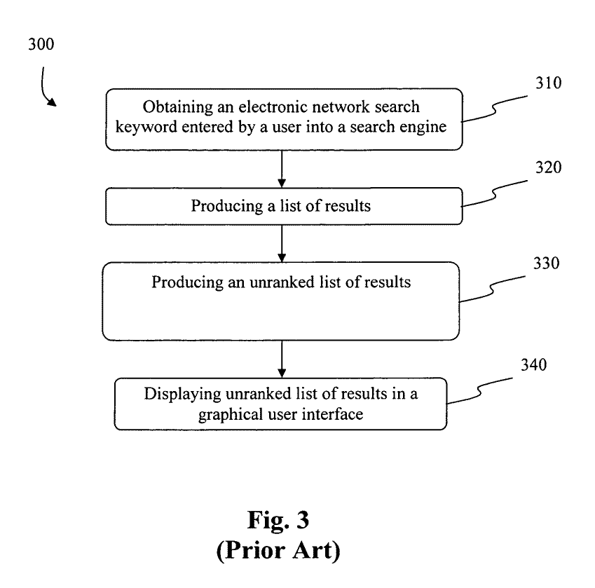

FIG. 4 depicts a flow chart diagram of the method steps in an exemplary embodiment of the present invention.

FIG. 5 depicts an exemplary embodiment of a third graphical user interface of the present invention.

FIG. 6 depicts an exemplary embodiment of a fourth graphical user interface of the present invention.

FIG. 7 depicts an exemplary embodiment of a fifth graphical user interface of the present invention.

FIG. 8 depicts an exemplary embodiment of a sixth graphical user interface of the present invention..

FIG. 9 depicts an exemplary embodiment of a seventh graphical user interface of the present invention.

FIG. 10 depicts an exemplary embodiment of a first graphical user interface of the present invention.

FIG. 11 depicts an exemplary embodiment of a first graphical user interface module of the present invention.

FIG. 12 depicts an exemplary embodiment of a second graphical user interface module.

FIG. 13 depicts an exemplary embodiment of a first graphical user interface and an exemplary embodiment of a second graphical user interface of the invention as displayed in conjunction with traditional search engine results by the system and method of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following preferred embodiments of the invention are set forth without any loss of generality to, and without imposing limitations upon, the claimed invention.

The present invention may include various steps, which will be described below. The steps of the present invention may be performed by hardware components or may be embodied in machine-executable instructions, which may be used to cause a general-purpose or special-purpose processor or logic circuits programmed with the instructions to perform the steps. Alternatively, the steps may be performed by a combination of hardware and software.

It is appreciated that a lesser or more equipped computer system than the example described above may be desirable for certain implementations. Therefore, the configuration of computer system may vary from implementation to implementation depending upon numerous factors, such as price constraints, performance requirements, technological improvements, and/or other circumstances.

Current day search marketing methods involve displaying text advertisements along side natural search results that have been returned from a keyword search query. Text advertisements are sponsored and paid by merchants who wish to display specific advertisements that are relevant to the user's search query. Merchants pay the search engine sites everytime a user clicks on a text advertisement. Unfortunately, these merchants are receiving and paying for clicks from users who may or may not have purchase intentions relevant to the merchant's product or services. The system and method of the invention enables and incentivises a user to announce his or her purchase intentions when searching and surfing throughout the web or any other available network would allow merchants to intereact differently with those visitors who are more likely to be making a near-term purchase.

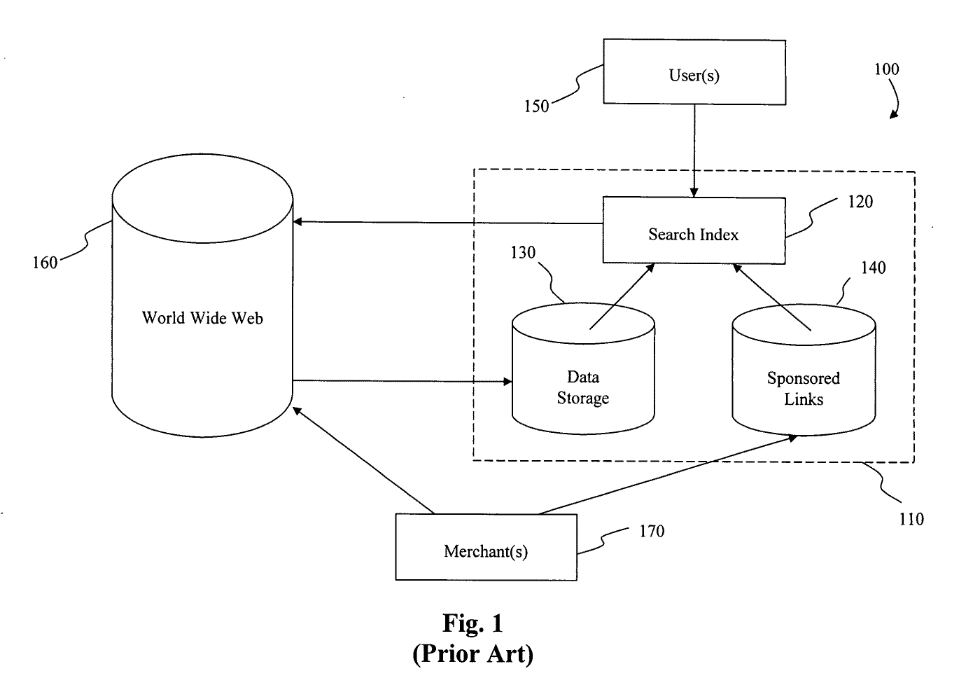

As shown in FIG. 1, typical search engine technologies 100 in accordance with the prior art use keyword search engines 110 that include a keyword search index 120 communicably coupled to a data storage 130 and sponsored links 140. The keyword search index 120 is populated with terms used by buyers 150 when conducting a search. The keyword search engine 110 scours the Internet (World Wide Web) 160 for documents or web pages that contain the keywords. The documents, web pages or relevant data to link or point to such documents and web pages are stored in data storage 130, which is used to further populate the keyword search index 120. The searching, storing, and selecting mechanisms are extremely complicated and require massive data storage and processing power. Sellers 170 typically purchase the option to have their sponsored links 140 included in the search results provided to buyers 150 based on various criteria. As a result, advertising generally drives current search engine technologies.

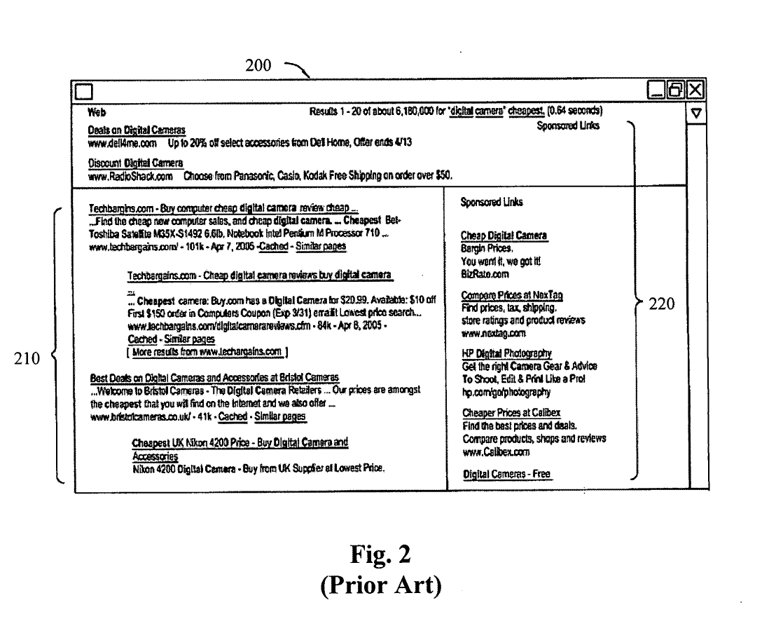

Current technologies do not take into account the social values or personal contact network of the consumer because such information is not available to the current search engines. Clicking on a link often leads to more time searching a website. Current search engine technologies do not maximize the Internet's full potential because they do not give sellers proactive tools. They still have to wait for a buyer to click on a sponsored link or organic listing. FIG. 2 depicts typical Google™ search result including an example of a user interface and search result in accordance with the prior art. It is typical for Google™ to return a bewildering array of more than 6 million results 200. The “organic” results 210 are on the left and the “sponsored links” 220 are on the top left and on the right. Ninety-eight percent of Google's revenue comes from these sponsored links 220. Thousands of search engine marketing (SEM) companies help advertisers position themselves close to the top of organic 210 and sponsored search results 220 to increase the likelihood of being noticed by a prospective buyer. As mentioned above, these legacy search engines are unable to match the social values, non-profit organizations, personal network, affiliations, connections, and so forth of the user to any merchant who is listed in the electronic network search.

As used herein, “user preselected criteria” means at least one criteria that is desired be utilized by the method and system of the invention for producing a ranked list of search results. Such criteria may be any criteria deemed important by operator of the invention, but may be, for example, charitable organization; geographic location; geographic proximity to the user; non-profit entity; political affiliation; religion; personal contacts of the user such as friends, favorite businesses, family members, and the like; colleges, schools, or universities or the like; hobbies; favorite sports teams; or any other criteria defining or describing a personal preference of the user.

As used herein, “merchant preselected criteria” means at least one criteria that is desired be utilized by the method and system of the invention for producing a ranked list of search results. Such criteria may be any criteria deemed important by operator of the invention, but may be for example, charitable organization; geographic location; geographic proximity to the user; non-profit entity; political affiliation; religion; personal contacts of the merchant such as friends, favorite businesses, associated businesses, family members, and the like; colleges, schools, or universities or the like; hobbies; favorite sports teams; or any other criteria defining or describing a personal preference of the participating merchant.

As used herein, “participating merchant” means a person or entity who offers a product or service and who has provided their contact information to the method and system of the invention for registration and who has provided a description of the products or services they offer to the method of the invention.

As used herein, “product or service information” means descriptive information, which may include nomenclature information, regarding any products offered by a participating merchant, or any services offered by a participating merchant, or both, and may include keyword information descriptive of any product or service offered by a participating merchant such that the product or service information may result in a hit on a desired keyword search, when the product or service information is subjected to a search by a keyword matching algorithm such as is usually used in database search tools, search engines, and the like. Product or service information may include descriptive information regarding one or a plurality of goods or services. A participating merchant need not provide any product or service information to the method and system of the invention.

As used herein, “shared social interest” means at least one social interest that is similar as between user preselected criteria for a particular user and merchant preselected criteria for a particular merchant. Such social interest may be, for example, a supported charitable organization, a non-profit organization, a religion, a particular social interest such as global warming, a school, a social group or organization, or the like.

As used herein, “personal contact” means a trusted user who is identified by a trusting user, such that the trusting user identifies the trusted user as a personal contact to the method and system of the invention. “Personal referral” means an entry into the method and system of the invention of comments regarding standard of quality of product or service or the like, of a participating merchant by a user. The method and system of the invention may display an icon or other graphical symbol to indicate in a ranked list of results that certain participating merchants have received referrals from a user's personal contacts.

A used herein, “referral group” means a group of users who have been individually selected by a user to be within a select group of users whom said user trusts in terms of theirjudgment regarding the selection of merchants providing products or services.

As used herein, “first graphical user interface” refers to a graphical user interface for displaying a ranked list of results.

As used herein, “second graphical user interface” refers to a graphical user interface for displaying additional information regarding a participating merchant.

As used herein, “third graphical user interface” refers to a graphical user interface for obtaining personal information from a user.

As used herein, “fourth graphical user interface” refers to a graphical user interface for obtaining social network information from a user.

As used herein, “fifth graphical user interface refers to a graphical user interface for obtaining social network information from a user.

As used herein, “sixth graphical user interface” refers to a graphical user interface for obtaining participating merchant charitable organization selection and obtaining participating merchant geographical location information.

As used herein, “seventh graphical user interface” refers to a graphical user interface for obtaining participating merchant social network information.

The method and system of the invention overcomes the obstacles of the prior art regarding the ability to rank search results based upon certain pre-selected criteria as follows.

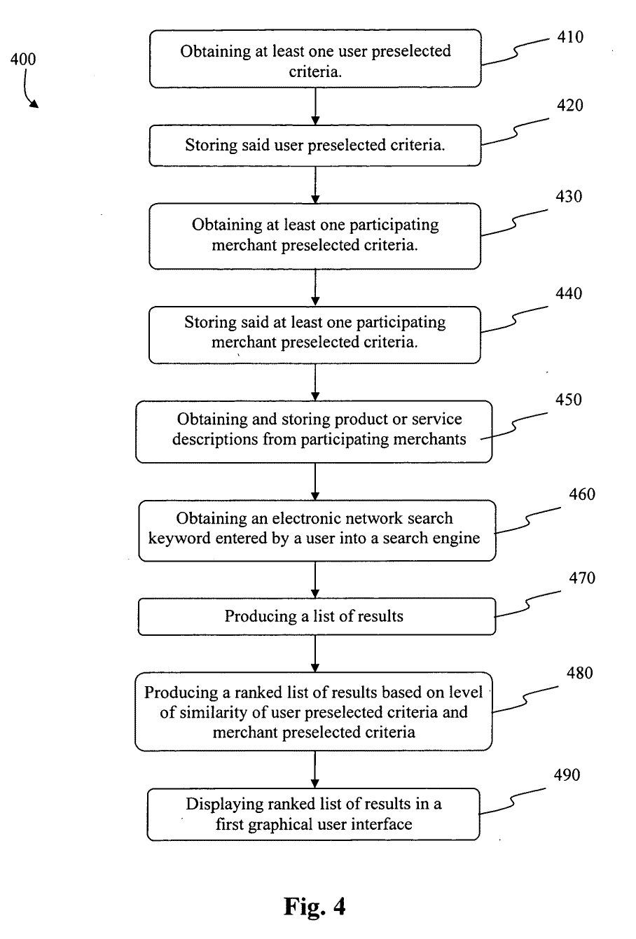

Referring now to FIG. 4, a flow diagram of a preferred embodiment of the method and system of the invention is shown. In step 410 the method obtains at least one user preselected criteria into the method of the invention. The user preselected criteria may be obtained by any of the well known means in the art for receiving information such as by electronic download over a network, transfer from storage media, or the like, but in a preferred embodiment the user preselected criteria is entered by the user, or by someone on behalf of the user, through an input graphical user interface which queries the user. After the user preselected criteria is obtained by the method 410, it is stored 420 for later use. Such storage 420 may be by any means known in the art including but not limited to storage in data base on magnetic, optical or other media, storage in electronic memory, or any other form of information storage. In step 430 the method obtains at least one merchant preselected criteria from a participating merchant into the method of the invention. The merchant preselected criteria may be obtained by any of the well known means in the art for receiving information such as by electronic download over a network, transfer from storage media, or the like, but in a preferred embodiment the merchant preselected criteria is entered by the merchant, or by someone on behalf of the merchant, through a graphical user interface which queries the merchant. After the merchant preselected criteria is obtained by the method 430, it is stored 440 for later use. Such storage 440 may be by any means known in the art including but not limited to storage in data base on magnetic, optical or other media, storage in electronic memory, or any other form of information storage. In step 460, the method and system of the invention obtains product or service information from at least one participating merchant and stores the product or service information by any of the known means known in the art including but not limited to storage in data base on magnetic, optical or other media, storage in electronic memory, or any other form of information storage. The merchant product or service information is stored in such a manner as to remain identified with a particular participating merchant. In this manner, for example, a database may be populated with participating merchant product or service information such that the database may be queried by a search engine, program, search algorithm, or the like for keyword matches against a desired keyword, and a list of resulting “hits” may be generated that lists the participating merchants for each hit.

Still referring to FIG. 4, the method and system of the invention obtains an electronic network search keyword 460. The electronic network search keyword may be obtained by a number of methods known in the art that can be applied without undue experimentation, but in a preferred embodiment, the electronic network search keyword is obtained by copying an electronic network search keyword entered by the user into a typical web search engine. One such technique known in the art for obtaining the electronic network search keyword in this manner is the technique known as “screen scraping”. For instance, if the user were interested in purchasing a new vehicle, they may enter the name of a preferred vehicle manufacturer into a typical web search engine graphical user interface as is normally done when searching the web. The method and system of a preferred embodiment of the invention would then obtain the electronic network search keyword by any method known for capturing a electronic network search keyword entered into a web search engine such as by a keystroke logger or by screen scraping.

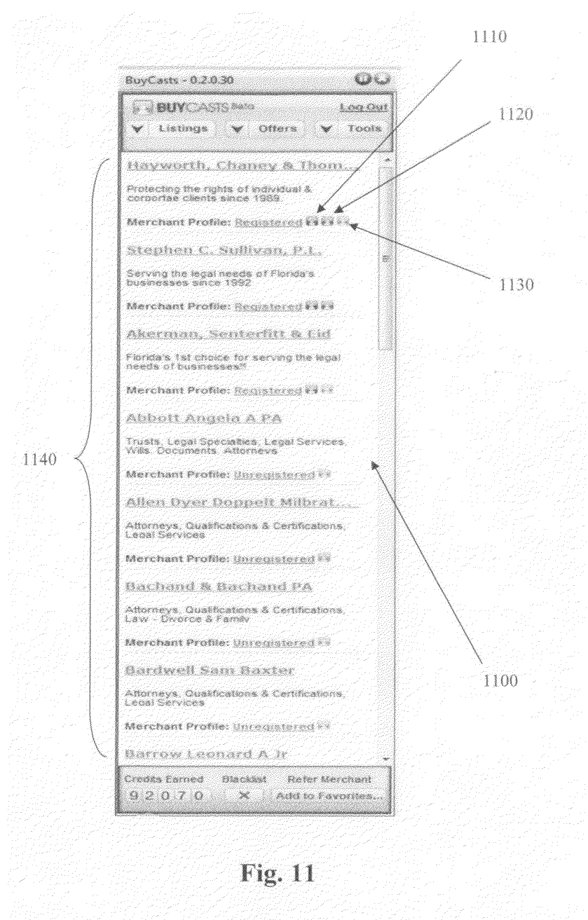

Still referring to FIG. 4, the method and system of the invention produces a list of results 470 by searching the participating merchant product or service information for matches with the electronic network search keyword. Participating merchants whose products or service information match the electronic network search keyword are compiled into a list of results 470. A ranked list of results 480 is produced by comparing the stored user preselected criteria from 420 with the stored merchant preselected criteria from 440 and ranking the participating merchants who are included in the list of results 470. The ranked list produced in this manner 480 is then displayed in rank order in a first graphical user interface 490. An example of a first graphical user interface is shown in FIG. 11. The user is then able to view the ranked list and select a participating merchant with whom the user is interested in doing business based on similarity of any of the preselected user criteria which the user deems important for their purposes.

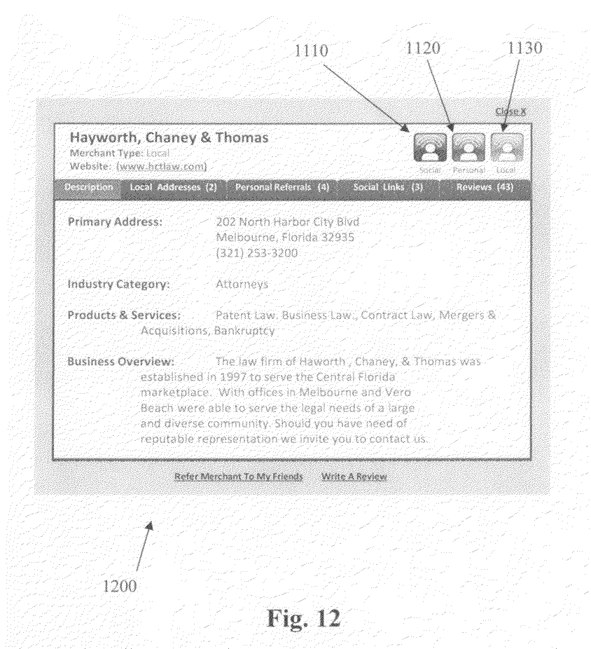

When the method and system of the invention compares the the stored user preselected criteria from 420 with the stored merchant preselected criteria from 440, it may compare the personal contacts obtained from the user to the personal referrals stored in the system by those person who are identified as personal contacts. Users of the invention are able to enter referrals into the system through a graphical user interface that allows for entry of identification of participating merchant, identification of the user who is making the referral entry, and other information. The personal referrals thus entered into the system may then be matched to any personal contacts entered by a user, and any resulting matching referrals may then be presented to the user, and an icon may then be displayed in proximity to the participating merchants' entry in a ranked list of results, thus indicating to a user that that particular participating merchant has received a referral from a personal contact of the user. The user may then have a higher degree of confidence than he/she would otherwise have in that particular participating merchant. An exemplary personal referral icon 1120 is shown in FIGS. 11 and 12.

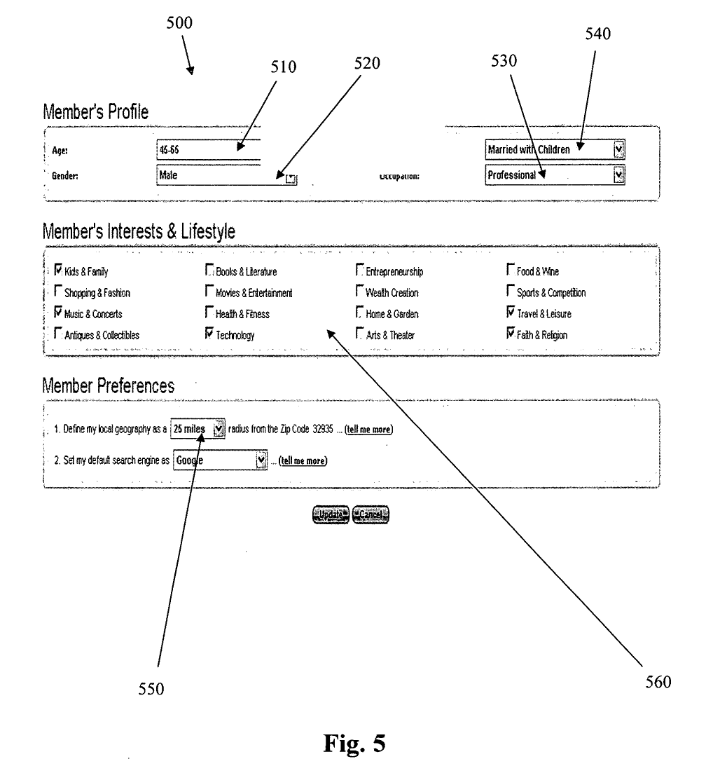

Referring now to FIG. 5, an embodiment of the third graphical user interface is shown. The third graphical user interface is utilized by the method and system of the invention to obtain personal information from the user. As can be seen by observing the example embodiment of the third graphical user interface shown in FIG. 5, the method and system of the invention is able to receive age information 510, gender information 520, marital and children information 540, occupational information 530, sure interest and lifestyle information 560, and user preference for geographic proximity of participating merchants 550. The information obtained in this manner may be stored by the system and method of the invention. The method of storage may be any method known in the computing arts such as, for example, optical media, magnetic media, electronic memory, or the like. The method of storage of information by the system and method of the invention is not a limitation of the present invention.

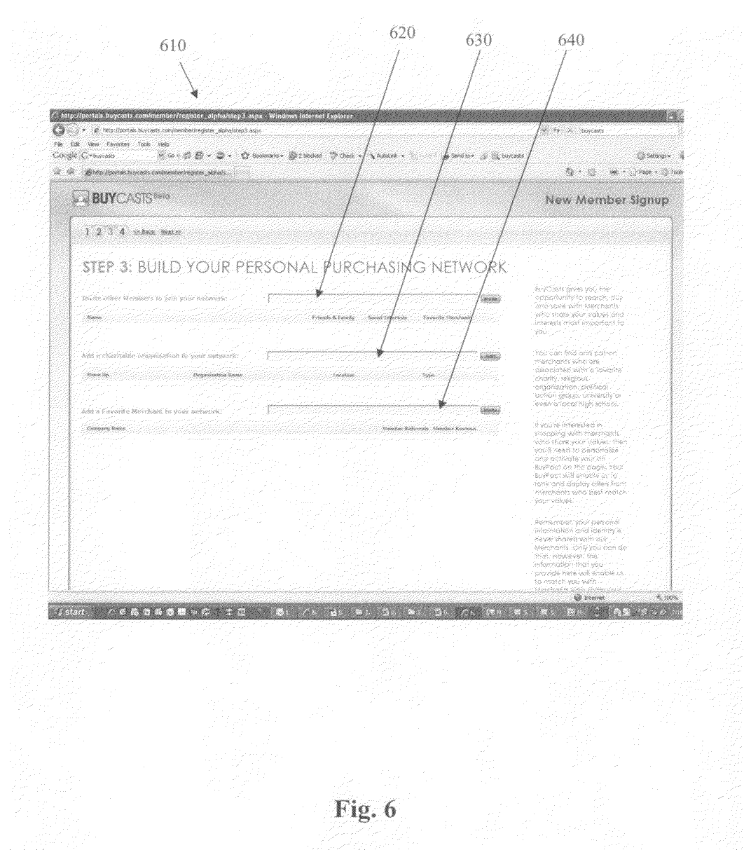

Referring now to FIG. 6, an embodiment of the fourth graphical user interface is shown. The fourth graphical user interface 610 is utilized by the method and system of the invention to obtain purchasing network information from the user, such as, for example, a user's selection of other users of the method and system of the invention as personal contacts 620, a user's selection of charitable organization 630, or a user's selection of favorite participating merchant 640. A user's selections may then be stored by the system and method of the invention. The method of storage may be any method known in the computing arts such as, for example, optical media, magnetic media, electronic memory, or the like. The method of storage of information by the system and method of the invention is not a limitation of the present invention.

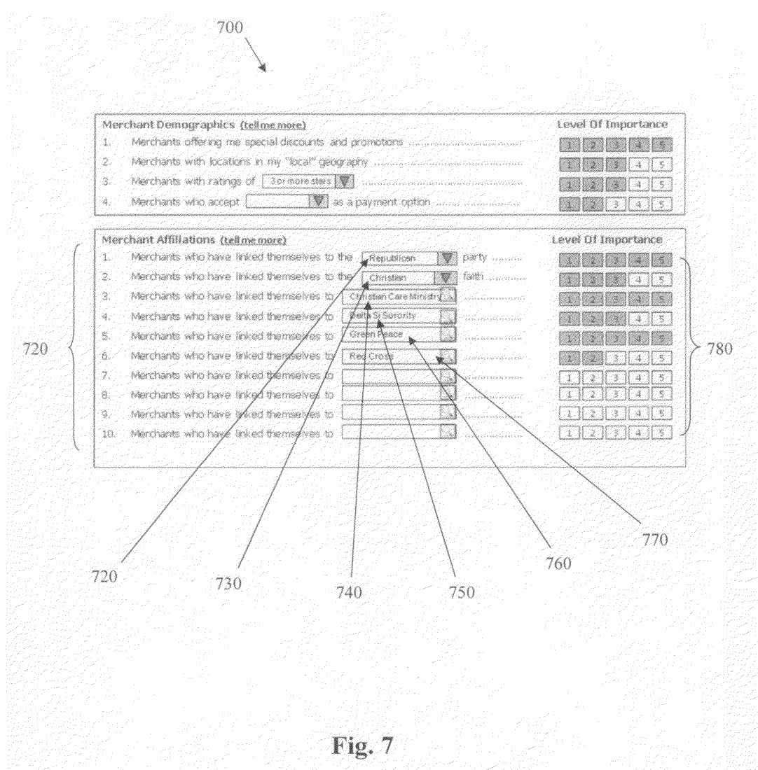

Referring now to FIG. 7, an embodiment of the fifth graphical user interface is shown. This interface may be used by the method and system of the invention to obtain a user's preselected criteria such as, for example, political party 720; religious faith 730; non-profit organization 740; fraternity or sorority 750; college, school, or university; environmental group 760; non-profit or charitable organization 770, and the like. The preselected criteria shown are as example only, and it is easily understood that any desired selection of organization, theme, religion, hobby, charity, or any other interest may be provided by the method and system of the invention to the user for inclusion within the user's preselected criteria. A user's selections may then be stored by the system and method of the invention. The method of storage may be any method known in the computing arts such as, for example, optical media, magnetic media, electronic memory, or the like. The method of storage of information by the system and method of the invention is not a limitation of the present invention.

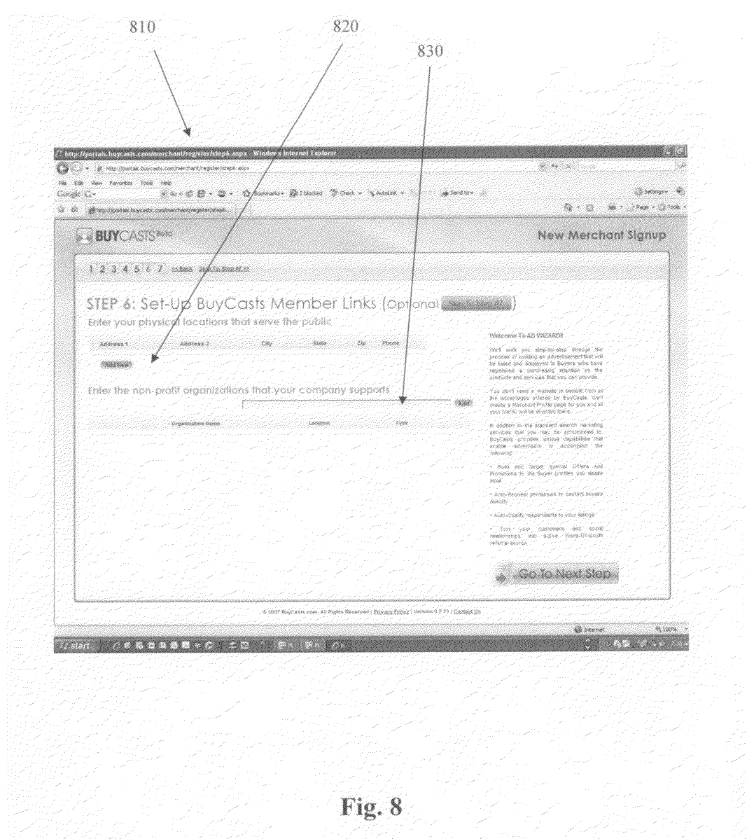

Referring now to FIG. 8, an embodiment of the sixth graphical user interface is shown. The fifth graphical user interface 810 is utilized by the method and system of the invention to obtain participating merchant geographic location information 820 or charitable organization information 830 from a participating merchant. A participating merchant's information may then be stored by the system and method of the invention. The method of storage may be any method known in the computing arts such as, for example, optical media, magnetic media, electronic memory, or the like. The method of storage of information by the system and method of the invention is not a limitation of the present invention.

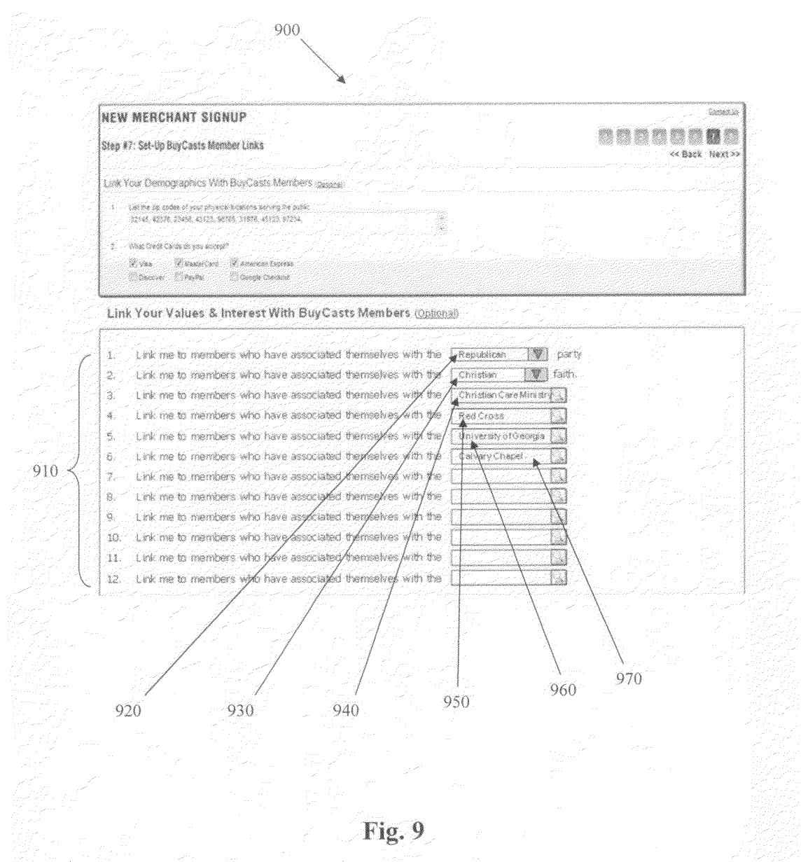

Referring now to FIG. 9, an embodiment of the seventh graphical user interface of the method and system is shown. The seventh graphical user interface 900 is utilized by the system to obtain participating merchant preselected criteria such as, for example, political party 920, religious faith 930, non-profit organization 940, charitable organization 950, college, school, or university 960, church 970, and the like. The preselected criteria shown are as example only, and it is easily understood that any desired selection of organization, theme, religion, hobby, charity, or any other interest may be provided by the method and system of the invention to the participating merchant for inclusion within the participating merchant's preselected criteria. A participating merchant's selections may then be stored by the system and method of the invention. The method of storage may be any method known in the computing arts such as, for example, optical media, magnetic media, electronic memory, or the like. The method of storage of information by the system and method of the invention is not a limitation of the present invention.

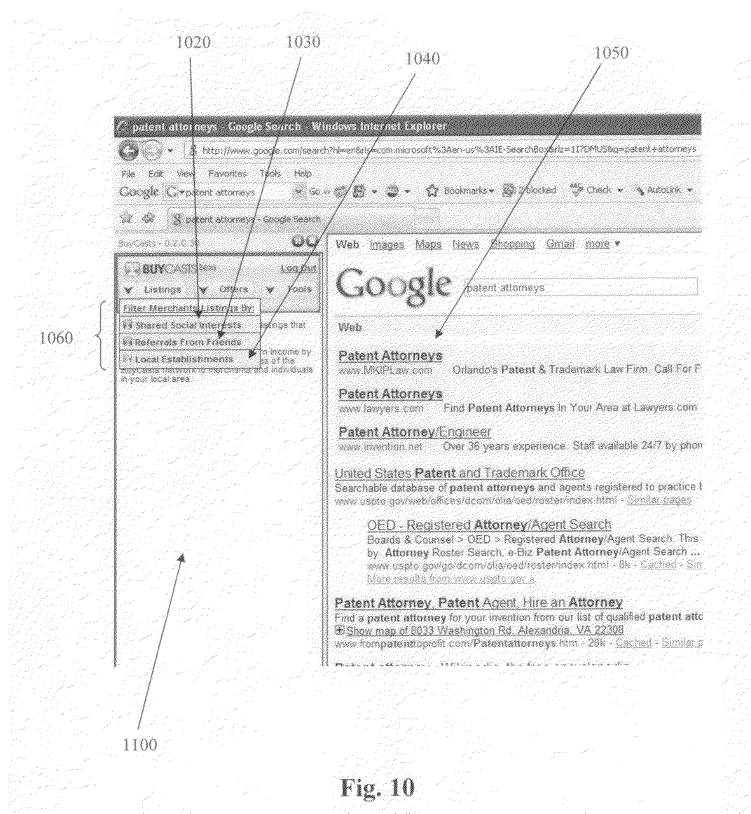

The user may be given the opportunity to select from the user preselected criteria in order to choose one or more criteria or group of criteria they wish to use in the participating merchant selection process. Referring now to FIG. 10, an embodiment of the first graphical user interface 1100 is shown on the left hand side of the figure. In the example shown, pull down menu 1060 provides three options allowing a user to select which one of the criteria shown are to be used in the ranking of merchants for display in the ranked list of results in the graphical user interface 1100. While three options are shown, the number of options presented to the user in this manner may be one or more options, up to any number which can reasonably fit within the first graphical user interface as desired by the operator of the method an system of the invention. In the example shown in FIG. 10, the user is provided with three criteria by which to rank participating merchants in the ranked list of results: shared social interests 1020, referrals from friends (i.e. personal referrals) 1030, and local establishments (i.e. participating businesses located within a preselected distance from the user) 1040. The user may select any of these three criteria by which to rank the participating merchants displayed in the ranked list of results.

Referring now to FIG. 11, an embodiment of the first graphical user interface 1100 is shown. In this embodiment, at least one match between one or more user preselected criteria and one or more merchant preselected criteria is depicted in the first graphical user interface by use of at least one icon, but preferably more than one icon comprising at least one of the following: a first icon for indicating a match of social values 1110, a second icon for indicating a match of personal contacts or referrals 1120, or a third icon indicating a match of geographical proximity 1130, wherein the at least one icon may be further individually identified by color or shape, or other graphical device such as a color bar or bars, bolded text, shading, blinking text, or any other graphical means, to indicate to the user that a participating merchant shares a social value when icon 1110 is present, a personal contact or referral when icon 1120 is present, or is within the user's preselected range of geographical proximity when icon 1130 is present. The method and system of the invention displays the at least one icon by matching a users preselected criteria to a participating merchants preselected criteria, and when a match is found, the appropriate icon is displayed. It is understood that the graphical depictions of the icons shown in the figures are exemplary only, and that the icons of the invention may take any shape or color the operator of the system of the invention desires as long as each icon is separately identifiable from all other icons. In a preferred embodiment, the at least one icon indicating a match between one or more user preselected criteria and one or more merchant preselected criteria is displayed in proximity to the merchant listing in the ranked list of results. There may be one or more icons utilized thus, depending upon the implementation of the method and system of the invention, or depending upon the desire of the user. For example, if a particular user and participating merchant have identified a shared social value, a specific icon is placed next to the participating merchant entry in the ranked list of results, and the presence of the icon is a visual graphic indication to the user that that participating merchant shares at least one social interest. Likewise, if a user has entered their geographic location such that the method and system of the invention have obtained their location, a specific icon is placed next to any participating merchant who is located within a preselected distance from the user, providing a graphical indication to the user that that participating merchant is located within the distance previously selected by the user. Also likewise, an icon may be placed next to any participating merchant who has been recommended by a member of a user's referral group, providing a graphical representation to the user that that participating merchant has been referred by a member of the user's referral group. In this manner it is possible to quickly identify to the user which of the participating members match criteria that may be used by the user to select a participating merchant. If a user is interested in finding out more information about a desired participating merchant, the user can click on a link provided near the desired participating merchant in the first graphical user interface, causing the system and method of the invention to display a second graphical user interface as shown in FIG. 12 in which is displayed additional information regarding a participating merchant.

An embodiment of the second graphical user interface is shown in FIG. 12. Referring now to FIG. 12, additional participating merchant information is displayed by the system and method of the invention for use by the user. Also shown are any icons representing a match of user preselected criteria to participating merchant preselected criteria. In the example shown, the first icon for indicating a match of social values 1110, the second icon for indicating a match of personal contacts or referrals 1120, and the third icon indicating a match of geographical proximity 1130 are depicted.

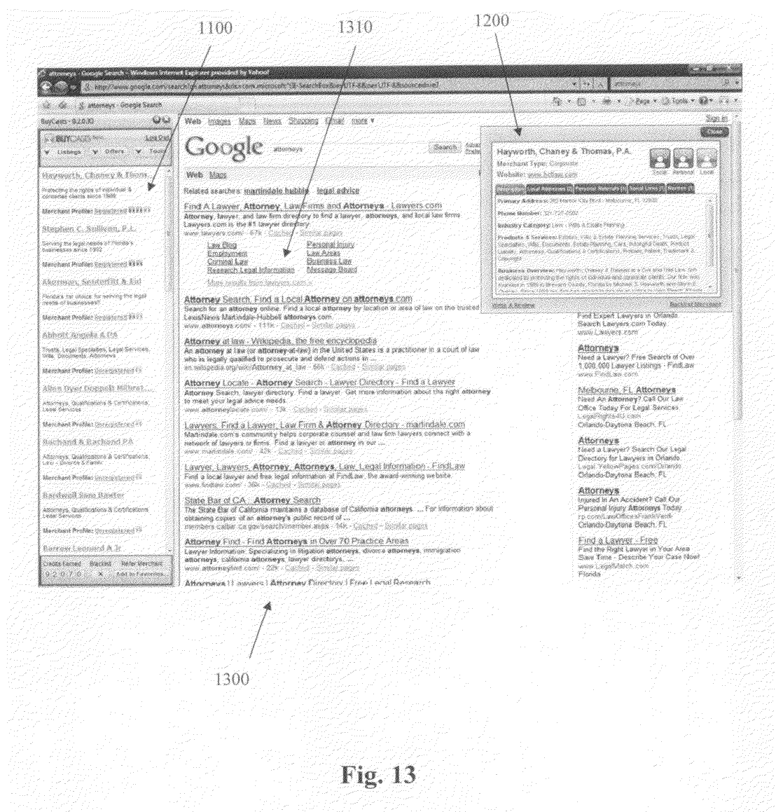

Referring now to FIG. 13, an embodiment of the system and method of the invention is shown 1300 in which the first graphical user interface 1100 is presented to the user by the system and method of the invention alongside a graphical user interface presented by a legacy art search engine showing legacy search engine search results 1310. An embodiment of the second graphical user interface 1200 is shown superimposed upon legacy search engine search results 1310 by the system and method of the invention. It can easily be seen and understood that the system and method of the invention thus provides the user with a first graphical interface 1100 depicting a ranked list of participating merchants, said participating merchants ranked in order of preference based upon preselected criteria by the user, further comprising a graphical indication of matches between the user's preselected criteria, personal referrals, and geographic proximity as indicated by three icons comprising a first icon for indicating a match of social values 1110, a second icon for indicating a match of personal contacts or referrals 1120, or a third icon indicating a match of geographical proximity 1130. Any number of icons may be utilized by the invention; it is understood that the at least one icon is depicted in the Figures as three icons by way of example, and not as a limitation.

A network device of a system of the present invention may comprise a personal computer running an Internet browser application, a digital cable box, and the like. Such a network device may further comprise a modem, a network interface card, or other interface devices known within the art, such as those used for coupling to Ethernet, token ring, or other types of physical and/or wireless communicative attachment means for purposes of providing a communication link to support a local or wide area network, for example. In any event, in this manner, the network device may be coupled to a number of clients and/or servers via a conventional network infrastructure, such as a company's Intranet and/or the Internet, for example.

The scope of the present invention includes a system for automatically linking at least one intending purchaser with at least one participating merchant via an electronic network. Such a system may comprise at least one database accessible via the electronic network for storing at least one key word associated with products or services of the at least one participating merchant. Participating merchants may provide search terms or descriptive terms that are associated with their respective goods or services. The at least one keyword may be compared to or correlated with the search terms used in an electronic network search performed by the intending purchaser.

The system of the present invention may further comprise a host server for communicating with the at least one database and with a network device via the electronic network and for executing computer-executable instructions. Such computer-executable instructions may include but are not limited to receiving at least one electronic network search input by at least one intending purchaser; in response to receiving the at least one electronic network search, querying the at least one intending purchaser to determine if the at least one electronic network search is related to a purchase intention of the at least one intending purchaser; receiving a confirmation from the at least one intending purchaser; in response to receiving the confirmation from at least one intending purchaser, displaying information of at least one participating merchant to the at least one intending purchaser when the electronic network search comprises at least one key word search term that correlates with the at least one key word associated with products or services of the at least one participating merchant; and offering at least one reward from the at least one participating merchant to the at least one intending purchaser for the at least one intending purchaser's interaction with the information of the at least one participating merchant.

The network device comprises, but is not limited to a personal computer running an Internet browser application, cable box capable of displaying at least one television advertisement of at least one merchant that correlates with the at least one electronic network search input by the at least one intending purchaser, and the like. While the examples disclosed mainly illustrate the method or system of the present invention being used over a network such as the Internet via a personal computer, other uses are within the scope of the invention. The present invention further encompasses the use of sharing the terms in an electronic network search of an intending purchaser over a cable and/or television network to allow participating merchants to display television advertisements to intending purchasers/viewers targeting the goods or services searched for in an electronic network search by the viewer.

It is understood that the system and method of the invention may be implemented by a number of equivalent means well known in the computing and relevant arts, and that the graphical user interfaces shown in the figures are exemplary only and the particular graphical representations shown are not to be construed as limitations on the invention. The scope of the invention includes all equivalent embodiments.

What is claimed is:

1. A method of linking at least one user with at least one participating merchant sharing at least one preselected criteria, via an electronic network, said method comprising the steps of:
obtaining at least one user preselected criteria;
obtaining at least one participating merchant preselected criteria;
obtaining at least one product or service description from said at least one participating merchant;
obtaining an electronic network search keyword from said at least one user;
producing a list of results comprising at least one participating merchant by matching said electronic network search keyword to said at least one product or service description;
producing a ranked list of results by ranking said list of results by matching said at least one user preselected criteria to said at least one merchant preselected criteria, and applying an importance rating predetermined by at least said one user; and
displaying said ranked list of results within a first graphical user interface module.

2. The method of claim 1, further comprising the step of:
displaying at least one icon associated with at least one of said at least one participating merchant in said ranked list of results to graphically depict said matching of said at least one user preselected criteria of said at least one user and said at least one participating merchant preselected criteria of said at least one participating merchant.

3. The method of claim 2, wherein said at least one icon depicts at least one detail selected from the group consisting of shared social interest, geographic proximity, and personal referrals.

4. The method of claim 1, wherein said at least one preselected criteria is selected from the group consisting of personal values, social values, interests, political party, faith, organizations, and affiliations.

5. The method of claim 1, further comprising the step of:
displaying a second graphical user interface module containing more detailed information regarding said at least one participating merchant upon said at least one user's selection of said at least one participating merchant from said ranked list of results displayed within said first graphical user interface.

6. The method of claim 2, further comprising the step of:
displaying a second graphical user interface module containing more detailed information regarding said at least one participating merchant upon said at least one user's selection of said at least one participating merchant from said ranked list displayed within said first graphical user interface.

7. A method of linking at least one user with at least one participating merchant sharing at least one preselected criteria via an electronic network, said method comprising the steps of:
obtaining an electronic network search from said at least one user, wherein said electronic network search comprises at least one keyword;
comparing said at least one keyword of said electronic network search to descriptions of products or services available from said at least one participating merchant;
ranking said at least one participating merchant having said goods or said services available by matching said at least one user preselected criteria of said at least one user and said at least one participating merchant preselected criteria of said at least one participating merchant, wherein said at least one preselected user criteria and said at least one participating merchant preselected criteria are selected from the group consisting of personal values, social values, interests, political party, faith, organizations, and affiliations;
displaying a ranked list of results of said at least one participating merchant to said at least one user, wherein said ranked list of results is displayed within a first graphical user interface; and
displaying at least one icon associated with each of said at least one participating merchant in said ranked list of results to graphically depict said level of similarity of said at least one preselected criteria of said at least one user and said at least one preselected criteria of said at least one participating merchant.

8. The method of claim 7, further comprising the step of:
displaying a second graphical user interface containing more detailed information regarding said at least one participating merchant upon said at least one user's selection of said at least one participating merchant from said ranked list of results displayed within said first graphical user interface.

9. The method of claim 8, wherein said second graphical user interface displays at least one tab pertaining to said at least one icon, wherein said at least one icon comprises a social links icon, a local addresses icon, and a personal referrals icon and said second graphical user interface module displays a social links tab, a local addresses tab, and a personal referrals tab.

10. The method of claim 9, wherein said at least one icon depicts at least one detail selected from the group consisting of social links, local addresses, and personal referrals.

11. The method of claim 10, wherein said at least one icon comprises a social links icon, a local addresses icon, and a personal referrals icon and said second graphical user interface module comprises a social links tab, a local addresses tab, and a personal referrals tab.

12. An apparatus linking at least one user with at least one participating merchant sharing at least one preselected criteria via an electronic network, said apparatus comprising:
a memory that stores executable instructions for ranking said at least one participating merchant having products or services available based on said at least one preselected criteria; and
a processor that executes said instructions to:
obtain an electronic network search from said at least one user, wherein said electronic network search comprises at least one keyword;
compare said at least one keyword of said electronic network search to descriptions of said products or said services available from said at least one participating merchant;
rank said at least one participating merchant having said goods or said services available based on the level of similarity of said at least one preselected criteria of said at least one user and said at least one preselected criteria of said at least one participating merchant; and
display a ranked list of results of said at least one participating merchant to said at least one user, wherein said ranked list of results is displayed within a first graphical user interface module.

13. The apparatus of claim 12, wherein said processor further executes instructions to:
display at least one icon associated with each of said at least one participating merchant in said ranked list of results to graphically depict said level of similarity of said at least one preselected criteria of said at least one user and said at least one preselected criteria of said at least one participating merchant.

14. The apparatus of claim 13, wherein said at least one icon comprises a social links icon, a local addresses icon, and a personal referrals icon.

15. The apparatus of claim 14, wherein said processor further executes instructions to:
display a second graphical user interface module containing more detailed information regarding said at least one participating merchant upon said at least one user's selection of said at least one participating merchant from said ranked list of results displayed within said first graphical user interface module.

16. The apparatus of claim 15, wherein said second graphical user interface module displays a social links tab, a local addresses tab, and a personal referrals tab.
